(19) United States
(12) Patent Application Publication
(10) Pub. No.: US 2009/0051800 A1
(43) Pub. Date: Feb. 26, 2009

(54) SOLID-STATE IMAGE PICKUP DEVICE, IMAGE PICKUP APPARATUS AND DRIVE METHOD OF SOLID-STATE IMAGE PICKUP DEVICE

(76) Inventor: Tomohito NAGATA, Miyagi (JP)

Correspondence Address: BIRCH STEWART KOLASCH & BIRCH, PO BOX 747, FALLS CHURCH, VA, 22040-0747, US

(21) Appl. No.: 12/190,542

(22) Filed: Aug. 12, 2008

(30) Foreign Application Priority Data
Aug. 14, 2007 (JP) P2007-211505

(51) Int. Cl. H04N 5/335

(52) U.S. Cl. 348/311; 348/E05.091

(57) ABSTRACT

A solid-state image pickup device includes R photoelectric conversion elements, G photoelectric conversion elements, and B photoelectric conversion elements. A charge read part is provided between each of the R photoelectric conversion elements, the G photoelectric conversion elements, and the B photoelectric conversion elements and a vertical charge transfer passage on the right side corresponding thereto. Another charge read part is provided between the G photoelectric conversion element and the vertical charge transfer passage on the left side of the G photoelectric conversion element. A voltage can be applied separately to the charge read part and the another charge read part.

### CROSS-REFERENCE TO RELATED APPLICATIONS

This application is based on and claims priority under 35 USC 119 from Japanese Patent Application No. 2007-211505 filed Aug. 14, 2007; the entire contents of which are incorporated herein by reference.

### BACKGROUND

1. Technical Field

This invention relates to a solid-state image pickup device having a plurality of photoelectric conversion element columns each having a plurality of photoelectric conversion elements arranged in a predetermined direction.

2. Related Art

Patent document 1 (JP 2004-214363 A) proposes a solid-state image pickup device having a large number of photoelectric conversion elements for making it possible to adopt various drive methods by providing two charge read gates for all photoelectric conversion elements. In the solid-state image pickup device, an image pickup charge and a smear charge can be obtained alternately from the charge transfer passage corresponding to odd-numbered columns and the charge transfer passage corresponding to even-numbered columns, and a signal responsive to the smear charge adjacent to the image pickup charge is subtracted from a signal responsive to the image pickup charge, whereby smear correction is made possible.

In the solid-state image pickup device disclosed in patent document 1, two charge read gates are provided for all photoelectric conversion elements and therefore the opening areas of all photoelectric conversion elements lessen and sensitivity is degraded.

It is therefore an object of the invention to provide a solid-state image pickup device capable of making a highly accurate smear correction while preventing degradation of sensitivity.

### SUMMARY

[1] According to an aspect of the invention, a solid-state image pickup device includes a plurality of photo electric conversion element columns, a charge transfer passage, a first charge read part and a second charge read part. Each photoelectric conversion element columns has a plurality of photoelectric conversion elements arranged in a predetermined direction, the plurality of photoelectric conversion element columns which are disposed in an orthogonal direction to the predetermined direction. The charge transfer passage is provided corresponding to each of the photoelectric conversion element columns on a side of the photoelectric conversion element column for transferring charge occurring in the photoelectric conversion elements contained in the photoelectric conversion element column in the predetermined direction. The first charge read part is provided between the charge transfer passage and each of the photoelectric conversion elements contained in the photoelectric conversion element column corresponding to the charge transfer passage for reading the charge stored in the corresponding photoelectric conversion element to the charge transfer passage. The photoelectric conversion element columns are arranged alternately in the orthogonal direction being first photoelectric conversion element columns and other photoelectric conversion element columns being second photoelectric conversion element columns. The second charge read part is provided between each of at least some of the photoelectric conversion elements contained in the second photoelectric conversion element column and the charge transfer passage on the opposite side of the second photoelectric conversion element column to the side where the charge transfer passage corresponding to the second photoelectric conversion element column exists for reading the chare stored in the corresponding photoelectric conversion element to the charge transfer passage on the opposite side.

[2] According to the image pickup device of [1], a read pulse may read out the charge from the photoelectric conversion element to the charge transfer passage. The read pulse may be applied separately to the second charge read part and the first charge read part adjacent to each of at least some of the photoelectric conversion elements.

[3] According to the image pickup device of [1], each of the first photoelectric conversion element columns may have a B photoelectric conversion element for detecting light in a blue wave range and an R photoelectric conversion element for detecting light in a red wave range. Each of the second photoelectric conversion element columns may have G photoelectric conversion elements for detecting light in a green wave range.

[4] According to the image pickup device of [1], the first and second photoelectric conversion element columns may be shifted from each other in the predetermined direction roughly by a half of the arrangement pitch of the photoelectric conversion elements contained each of the photoelectric conversion element columns.

[5] According to the image pickup device of [1], a image pickup apparatus includes the solid-state image pickup device of [1]. The image pickup apparatus may include a drive unit. The drive unit may drive the solid-state image pickup device in different types of drive modes. The different types of drive modes contain a first drive mode and a second drive mode. The first drive mode is a drive mode for applying a read pulse for reading the charge from each of the photoelectric conversion elements to the charge transfer passage to the first charge read part, reading the charges stored in the photoelectric conversion elements contained in the first photoelectric conversion element column to the charge transfer passage corresponding to the first photoelectric conversion element column, and reading the charges stored in the photoelectric conversion elements contained in the second photoelectric conversion element column to the charge transfer passage corresponding to the second photoelectric conversion element column, and applying a predetermined pulse to the charge transfer passage and transferring the charges read to the charge transfer passage corresponding to the first photoelectric conversion element column and the charges read to the charge transfer passage corresponding to the second photoelectric conversion element column in the predetermined direction. The second drive mode is a drive mode for applying the read pulse to each of the first charge read parts adjacent to the first photoelectric conversion element column and reading the charges stored in the photoelectric conversion elements contained in the first photoelectric conversion element column to the charge transfer passage corresponding to the first photoelectric conversion element column, applying the read pulse to each of the second charge read parts adjacent to the second photoelectric conversion element column and reading the charges stored in the photoelectric conversion elements contained in the second photoelectric conversion element column to the charge transfer passage corresponding to the first photoelectric conversion element column adjacent to the second photoelectric conversion element column, and applying a predetermined pulse to the charge transfer passage and transferring the charges read to the charge transfer passage corresponding to the first photoelectric conversion element column and smear charge existing in the charge transfer passage corresponding to the second photoelectric conversion element column in the predetermined direction.

[6] According to the image pickup apparatus of [5], the image pickup apparatus may further include a smear correction unit. The smear correction unit may executes smear correction by subtracting a signal responsive to the charges transferred over the charge transfer passage corresponding to the second photoelectric conversion element column adjacent to the first photoelectric conversion element column from a signal responsive to the charges transferred over the charge transfer passage corresponding to the first photoelectric conversion element column, output from the solid-state image pickup device according to the second drive mode.

[7] According to the image pickup apparatus of [1], a drive method includes driving a solid-state image pickup device of [1] by selecting any of different types of drive modes which contain a first drive mode and a second drive mode. The first drive mode includes: applying a read pulse for reading the charge from each of the photoelectric conversion elements to the charge transfer passage to the first charge read part; reading the charges stored in the photoelectric conversion elements contained in the first photoelectric conversion element column to the charge transfer passage corresponding to the first photoelectric conversion element column; and reading the charges stored in the photoelectric conversion elements contained in the second photoelectric conversion element column to the charge transfer passage corresponding to the second photoelectric conversion element column; applying a predetermined pulse to the charge transfer passage; and transferring the charges read to the charge transfer passage corresponding to the first photoelectric conversion element column and the charges read to the charge transfer passage corresponding to the second photoelectric conversion element column in the predetermined direction. And the second drive mode includes: applying the read pulse to each of the first charge read parts adjacent to the first photoelectric conversion element column; reading the charges stored in the photoelectric conversion elements contained in the first photoelectric conversion element column to the charge transfer passage corresponding to the first photoelectric conversion element column; applying the read pulse to each of the second charge read parts adjacent to the second photoelectric conversion element column; reading the charges stored in the photoelectric conversion elements contained in the second photoelectric conversion element column to the charge transfer passage corresponding to the first photoelectric conversion element column adjacent to the second photoelectric conversion element column; applying a predetermined pulse to the charge transfer passage; and transferring the charges read to the charge transfer passage corresponding to the first photoelectric conversion element column and smear charge existing in the charge transfer passage corresponding to the second photoelectric conversion element column in the predetermined direction.

According to [1] to [7], there can be provided a solid-state image pickup device capable of making a highly accurate smear correction while preventing degradation of sensitivity.

### BRIEF DESCRIPTION OF THE DRAWINGS

FIG. 1 is a drawing to show the schematic configuration of a digital camera as an example of an image pickup apparatus to describe an embodiment of the invention.

FIG. 2 is a plan pattern diagram to show the schematic configuration of a solid-state image pickup device 5 shown in FIG. 1.

FIG. 3 is a timing chart to show the transfer pulse state at the time of a still image photographing mode of the solid-state image pickup device of a first embodiment of the invention.

FIG. 4 is a drawing to show the read state of the charge from each photoelectric conversion element at the time of the still image photographing mode in the solid-state image pickup device of the first embodiment of the invention.

FIG. 5 is a timing chart to show the transfer pulse state at the time of a moving image photographing mode of the solid-state image pickup device of the first embodiment of the invention.

FIG. 6 is a drawing to show the read state of the charge from each photoelectric conversion element at the time of the moving image photographing mode in the solid-state image pickup device of the first embodiment of the invention.

FIG. 7 is a plan pattern diagram to show another configuration example of the solid-state image pickup device 5 shown in FIG. 1.

FIG. 8 is a timing chart to show the transfer pulse state at the time of a moving image photographing mode of a solid-state image pickup device of a second embodiment of the invention.

FIG. 9 is a plan pattern diagram to show another configuration example of the solid-state image pickup device shown in FIG. 1.

FIG. 10 is a timing chart to show the transfer pulse state at the time of a moving image photographing mode of a solid-state image pickup device of a third embodiment of the invention.

### DETAILED DESCRIPTION

Referring now to the accompanying drawings, there are shown embodiments of the invention.

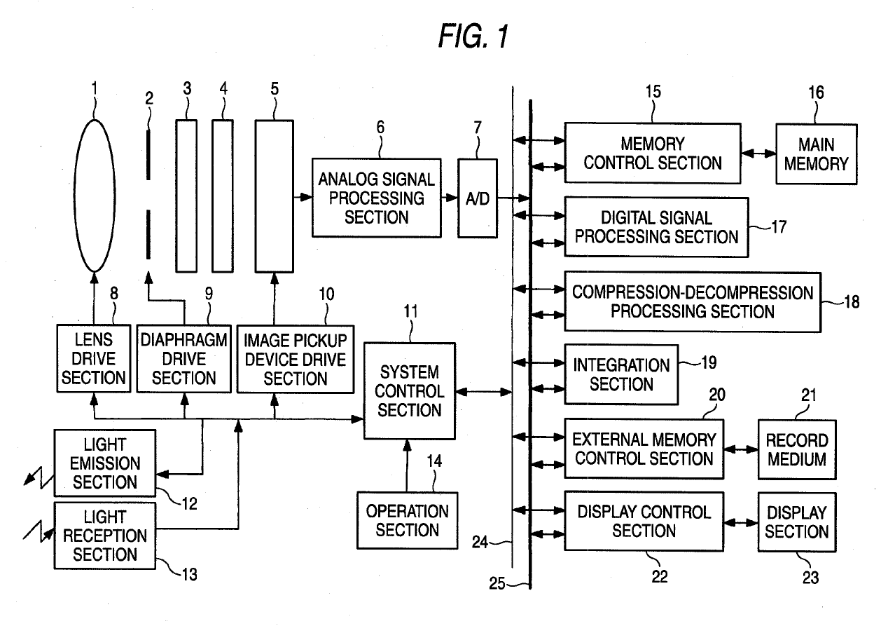

FIG. 1 is a drawing to show the schematic configuration of a digital camera as an example of an image pickup apparatus to describe an embodiment of the invention.

The image pickup system of the digital camera shown in the figure includes a taking lens 1, a solid-state image pickup device 5 of charge transfer type such as a COD type image sensor, and a diaphragm 2, an infrared cut filter 3, and an optical low-pass filter 4 provided between the taking lens 1 and the solid-state image pickup device 5.

A system control section 11 for controlling the whole electric control system of the digital camera controls a flash firing section 12 and a light reception section 13, controls a lens drive section 8 for adjusting the position of the taking lens 1 to a focal position and performing zoom adjustment, and controls the aperture amount of the diaphragm 2 through a diaphragm drive section 9 for adjusting the light exposure.

The system control section 11 drives the solid-state image pickup device 5 through an image pickup device drive section 10 and outputs a subject image picked up through the taking lens 1 as a color signal. A command signal from the user is input to the system control section 11 through an operation section 14.

The electric control system of the digital camera further includes an analog signal processing section 6 connected to output of the solid-state image pickup device 5 for performing analog signal processing of correlated double sampling processing, etc., and an A/D conversion circuit 7 for converting color signal of RGB output from the analog signal processing section 6 into a digital signal; the analog signal processing section 6 and the A/D conversion circuit 7 are controlled by the system control section 11.

The electric control system of the digital camera further includes main memory 16, a memory control section 15 connected to the main memory 16, a digital signal processing section 17 for performing interpolation computation, gamma correction computation, RGB/YC conversion processing, etc., and generating image data, a compression-decompression processing section 18 for compressing the image data generated by the digital signal processing section 17 into JPEG format and decompressing the compressed image data, an integration section 19 for integrating photometric data and finding the gain of white balance correction performed by the digital signal processing section 17, an external memory control section 20 to which a detachable record medium 21 is connected, and a display control section 22 to which a liquid crystal display section 23 installed on the back of the camera, etc., is connected; the components are connected by a control bus 24 and a data bus 25 and are controlled according to a command from the system control section 11.

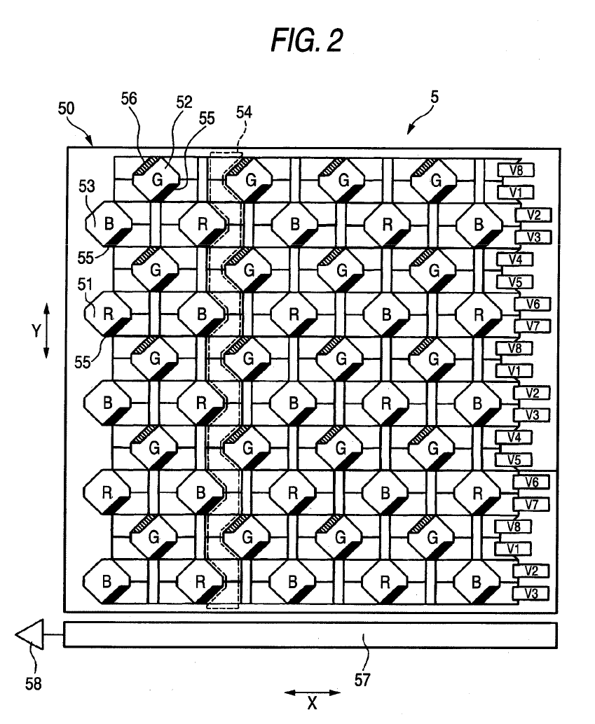

FIG. 2 is a plan pattern diagram to show one configuration example of the solid-state image pickup device 5 shown in FIG. 1.

The solid-state image pickup device 5 includes an RB photoelectric conversion element group made up of R photoelectric conversion elements 51 for detecting light (R light) in the wave range of red (R) and B photoelectric conversion elements 53 for detecting light (B light) in the wave range of blue (B), arranged like a tetragonal lattice in a row direction X and a column direction Y orthogonal to the row direction on a semiconductor substrate 50 and a G photoelectric conversion element group made up of G photoelectric conversion elements 52 for detecting light (G light) in the wave range of green (G) arranged like a tetragonal lattice in the row direction X and the column direction Y on the semiconductor substrate 50. The elements are placed at positions shifted in the row direction X and the column direction Y roughly by a half of the photoelectric conversion element arrangement pitch. Such a photoelectric conversion element arrangement is described in detail in JP Hei. 10-136391 A (corresponding to U.S. Pat. No. 6,236,434).

It can be said that the arrangement of the photoelectric conversion elements of the solid-state image pickup device 5 is arranging of (i) RB photoelectric conversion element columns made up of the R photoelectric conversion elements 51 and the B photoelectric conversion elements 53 arranged in the column direction Y and (ii) G photoelectric conversion element columns made up of the G photoelectric conversion elements 52 arranged in the column direction Y, alternately in the row direction X. It can also be said that the arrangement of the photoelectric conversion elements of the solid-state image pickup device 5 is arranging of (i) RB photoelectric conversion element rows made up of the R photoelectric conversion elements 51 and the B photoelectric conversion elements 53 arranged in the row direction X and (ii) G photoelectric conversion element rows made up of the G photoelectric conversion elements 52 arranged in the row direction X, alternately in the column direction Y.

Of the RB photoelectric conversion element rows, each odd-numbered RB photoelectric conversion element row counted from the upper end part of the solid-state image pickup device 5 has an alternating pattern of the B photoelectric conversion element 53 and the R photoelectric conversion element 51 arranged in this order in the row direction X starting at the B photoelectric conversion element 53 (hereinafter, this photoelectric conversion element row will be referred to as br photoelectric conversion element row); each even-numbered RB photoelectric conversion element row counted from the upper end part of the solid-state image pickup device 5 has an alternating pattern of the R photoelectric conversion element 51 and the B photoelectric conversion element 53 arranged in this order in the row direction X starting at the R photoelectric conversion element 51 (hereinafter, this photoelectric conversion element row will be referred to as rb photoelectric conversion element row).

In the right side of each RB photoelectric conversion element column and each G photoelectric conversion element column, vertical charge transfer passages 54 (only one is shown in FIG. 2) for transferring charges stored in the photoelectric conversion elements making up the photoelectric conversion element columns are formed in a one-to-one correspondence with the photoelectric conversion element columns. The vertical charge transfer passage 54 is formed of n-type impurities poured into a p well layer formed on an n-type silicon substrate, for example.

Transfer electrodes V1 to V8 to which transfer pulses of eight phases for transferring the charge read to the vertical charge transfer passage 54 are applied by the image pickup device drive section 10 are formed above the vertical charge transfer passage 54. Transfer pulse φV1 is applied to the transfer electrodes V1; transfer pulse φV2 is applied to the transfer electrodes V2; transfer pulse φV3 is applied to the transfer electrodes V3; transfer pulse φV4 is applied to the transfer electrodes V4; transfer pulse φV5 is applied to the transfer electrodes V5; transfer pulse φV6 is applied to the transfer electrodes V6; transfer pulse φV7 is applied to the transfer electrodes V7; and transfer pulse φV8 is applied to the transfer electrodes V8.

The transfer electrodes V1 to V8 are disposed in a zigzag line in the row direction X between the photoelectric conversion element rows so as to avoid the photoelectric conversion elements making up the photoelectric conversion element rows. In the upper part of the br photoelectric conversion element row, the transfer electrodes V1 and V2 are placed between the br photoelectric conversion element row and the adjacent G photoelectric conversion element row in order from the G photoelectric conversion element row. In the lower part of the br photoelectric conversion element row, the transfer electrodes V3 and V4 are placed between the br photoelectric conversion element row and the adjacent G photoelectric conversion element row in order from the br photoelectric conversion element row. In the upper part of the rb photoelectric conversion element row, the transfer electrodes V5 and V6 are placed between the rb photoelectric conversion element row and the adjacent G photoelectric conversion element row in order from the G photoelectric conversion element row. In the lower part of the rb photoelectric conversion element row, the transfer electrodes V7 and V8 are placed between the rb photoelectric conversion element row and the adjacent G photoelectric conversion element row in order from the rb photoelectric conversion element row.

Provided between each of the photoelectric conversion elements 51 to 53 and the vertical charge transfer passage 54 corresponding thereto is a charge read part 55 for reading a charge occurring in the corresponding element to the vertical charge transfer passage 54. The charge read part 55 is formed by a part of a p well layer formed on an n-type silicon substrate, for example. The charge read parts 55 are provided in the same direction relative to the photoelectric conversion elements 51 to 53 (slanting lower-right direction in the figure).

The transfer electrode V1 is formed above the charge read part 55 corresponding to each photoelectric conversion element of the odd-numbered G photoelectric conversion element row counted from the upper end part of the solid-state image pickup device 5. A read pulse is applied to the transfer electrode V1, whereby the charge stored in each photoelectric conversion element of the odd-numbered G photoelectric conversion element row can be read to the vertical charge transfer passage 54 on the right side of the corresponding photoelectric conversion element.

The transfer electrode V5 is formed above the charge read part 55 corresponding to each photoelectric conversion element of the even-numbered G photoelectric conversion element row counted from the upper end part of the solid-state image pickup device 5. A read pulse is applied to the transfer electrode V5, whereby the charge stored in each photoelectric conversion element of the even-numbered G photoelectric conversion element row can be read to the vertical charge transfer passage 54 on the right side of the corresponding photoelectric conversion element.

The transfer electrode V3 is formed above the charge read part 55 adjacent to each photoelectric conversion element of the br photoelectric conversion element row. A read pulse is applied to the transfer electrode V3, whereby the charge stored in each photoelectric conversion element of the br photoelectric conversion element row can be read to the vertical charge transfer passage 54 on the right side of the corresponding photoelectric conversion element.

The transfer electrode V7 is formed above the charge read part 55 adjacent to each photoelectric conversion element of the rb photoelectric conversion element row. A read pulse is applied to the transfer electrode V7, whereby the charge stored in each photoelectric conversion element of the rb photoelectric conversion element row can be read to the vertical charge transfer passage 54 on the right side of the corresponding photoelectric conversion element.

A charge read part 56 for reading a charge stored in the G photoelectric conversion element 52 to the vertical charge transfer passage 54 existing on the left side of the G photoelectric conversion element 52 is formed between the G photoelectric conversion element 52 and the vertical charge transfer passage 54 existing on the left side thereof. The charge read part 56 is formed by a part of a p well layer formed on an n-type silicon substrate, for example. The charge read parts 56 are provided in the same direction relative to all the G photoelectric conversion elements 52 (slanting upper-left direction in the figure).

The transfer electrode V8 is formed above the charge read part 56 adjacent to each photoelectric conversion element of the odd-numbered G photoelectric conversion element row counted from the upper end part of the solid-state image pickup device 5. A read pulse is applied to the transfer electrode V8, whereby the charge stored in each photoelectric conversion element of the odd-numbered G photoelectric conversion element row can be read to the vertical charge transfer passage 54 on the left side of the corresponding photoelectric conversion element.

The transfer electrode V4 is formed above the charge read part 56 corresponding to each photoelectric conversion element of the even-numbered G photoelectric conversion element row counted from the upper end part of the solid-state image pickup device 5. A read pulse is applied to the transfer electrode V4, whereby the charge stored in each photoelectric conversion element of the even-numbered G photoelectric conversion element row can be read to the vertical charge transfer passage 54 on the left side of the corresponding photoelectric conversion element.

A horizontal charge transfer passage 57 for transferring the charge transferred over the vertical charge transfer passage 54 in the row direction X is connected to the vertical charge transfer passage 54. An output amplifier 58 for converting the charged transferred over the horizontal charge transfer passage 57 into a voltage signal and outputting the voltage signal is connected to the horizontal charge transfer passage 57.

Next, a drive method of the described solid-state image pickup device 5 will be discussed.

(Still Image Photographing Mode)

When a still image photographing mode is set through the operation section 14, the image pickup device drive section 10 drives the solid-state image pickup device 5 by a drive method responsive to the still image photographing mode under the control of the system control section 11.

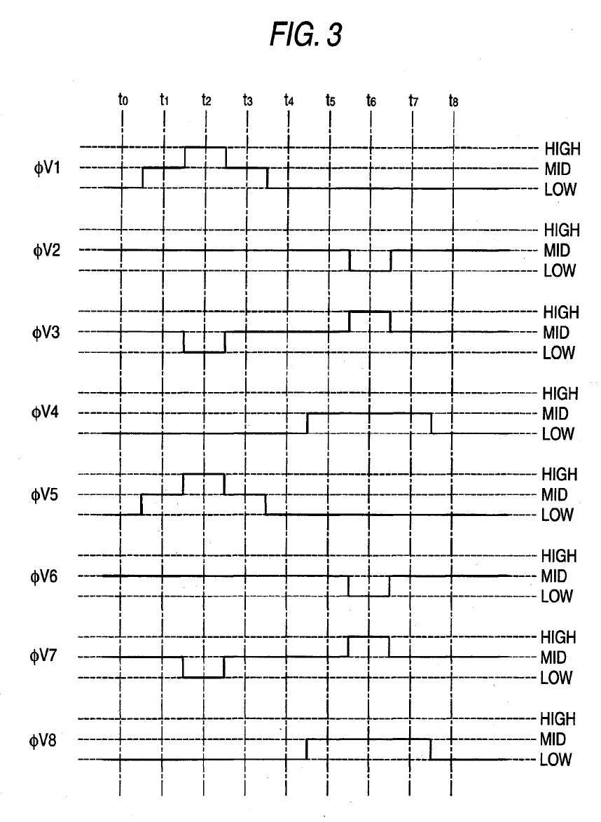

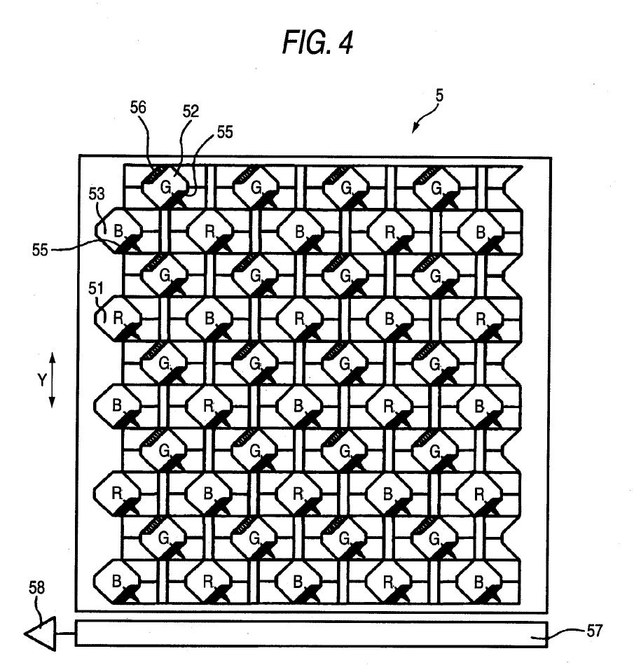

FIG. 3 is a timing chart to show the transfer pulse state at the time of the still image photographing mode of the solid-state image pickup device of a first embodiment of the invention. FIG. 4 is a drawing to show the read state of the charge from each photoelectric conversion element at the time of the still image photographing mode in the solid-state image pickup device of the first embodiment of the invention.

After the expiration of an exposure period, the image pickup device drive section 10 sets high the transfer pulse to be applied to the transfer electrode V1, V5 at a time t2 and reads the charge stored in the G photoelectric conversion element 52 to the vertical charge transfer passage 54 on the right part of the G photoelectric conversion element 52 through the charge read part 55, as indicated by the arrow in FIG. 4. Next, the image pickup device drive section 10 sets high the transfer pulse to be applied to the transfer electrode V3, V7 at a time t6 and reads the charges stored in the R photoelectric conversion element 51 and the B photoelectric conversion element 53 to the vertical charge transfer passage 54 on the right side of the R photoelectric conversion element 51 and the B photoelectric conversion element 53 through the charge read parts 55, as indicated by the arrow in FIG. 4. The image pickup device drive section 10 applies transfer pulses of a given pattern to the transfer electrodes V1 to V8 after the time t6, thereby transferring the charges read to the vertical charge transfer passage 54 to the horizontal charge transfer passage 57 and then applies transfer pulses of two phases to the horizontal charge transfer passage 57, transfers the charges transferred to the horizontal charge transfer passage 57 in the row direction X, and outputs a signal responsive to the charges from the output amplifier 58.

(Moving Image Photographing Mode)

When a moving image photographing mode is set through the operation section 14, the image pickup device drive section 10 drives the solid-state image pickup device 5 by a drive method responsive to the moving image photographing mode under the control of the system control section 11.

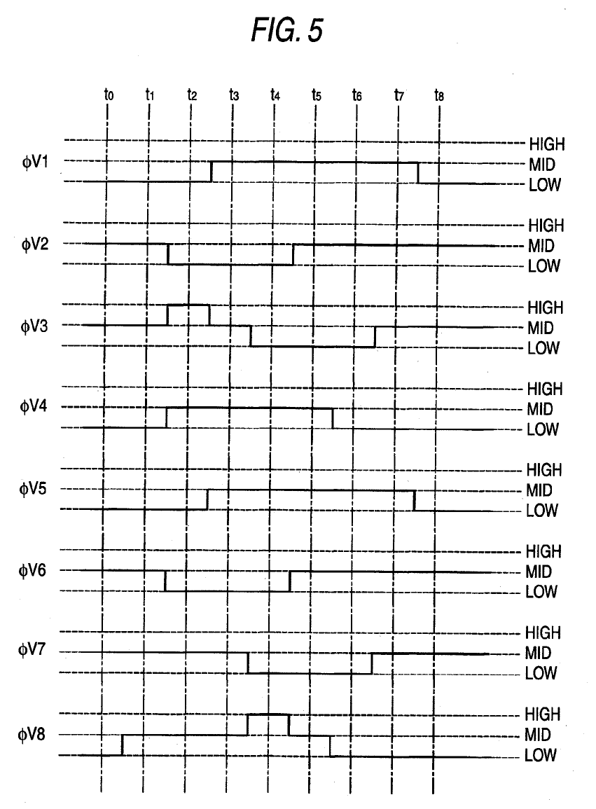

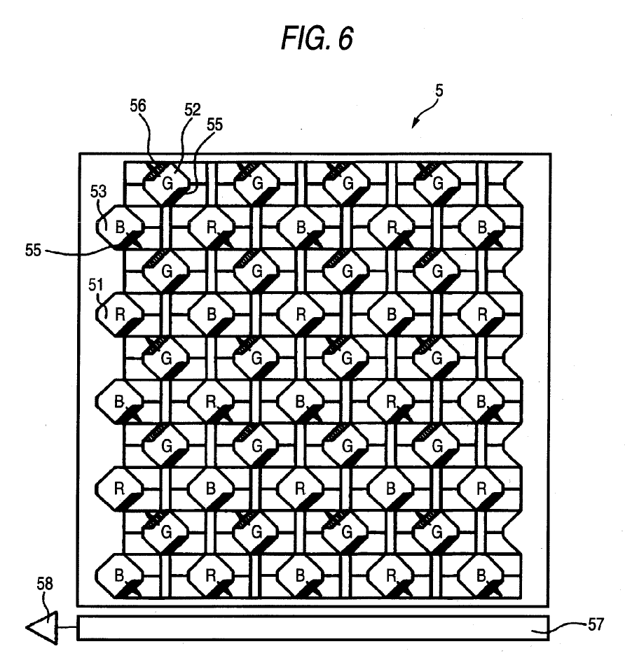

FIG. 5 is a timing chart to show the transfer pulse state at the time of the moving image photographing mode of the solid-state image pickup device of the first embodiment of the invention. FIG. 6 is a drawing to show the read state of the charge from each photoelectric conversion element at the time of the moving image photographing mode in the solid-state image pickup device of the first embodiment of the invention.

After the expiration of an exposure period, the image pickup device drive section 10 sets middle the transfer pulse to be applied to the transfer electrode V3, V4, V7, V8 at a time t2, forms an RB charge storing packet in the vertical charge transfer passage 54 below the transfer electrode V3, V4, forms a G charge storing packet in the vertical charge transfer passage 54 below the transfer electrode V7, V8, superposes a high read pulse on the transfer pulse to be applied to the transfer electrode V3, and reads the charges stored in the R photoelectric conversion element 51 and the B photoelectric conversion element 53 making up a hr photoelectric conversion element row to the RB charge storing packet formed in the vertical charge transfer passage 54 on the right side of the R photoelectric conversion element 51 and the B photoelectric conversion element 53 through the charge read parts 55, as indicated by the arrow in FIG. 6.

Next, the image pickup device drive section 10 moves the RB charge storing packet to below the transfer electrode V4, V5 and moves the G charge storing packet to below the transfer electrode V8, V1 at time t3, t4 and also superposes a high read pulse on the transfer electrode V8 at the time t4 and reads the charges stored in the G photoelectric conversion elements 52 making up an odd-numbered G photoelectric conversion element row to the G charge storing packet formed in the vertical charge transfer passage 54 on the left side of the G photoelectric conversion elements 52 through the charge read parts 56, as indicated by the arrow in FIG. 6.

Next, the image pickup device drive section 10 applies transfer pulses of a predetermined pattern to the transfer electrodes V1 to V8 after the time t4, thereby transferring the charges read to the vertical charge transfer passage 54 to the horizontal charge transfer passage 57 and then applies transfer pulses of two phases to the horizontal charge transfer passage 57, transfers the charges transferred to the horizontal charge transfer passage 57 in the row direction X, outputs a signal responsive to the charges from the output amplifier 58, and completes photographing of one frame.

According to the method, half thinning read of thinning out the charges from the even-numbered G photoelectric conversion element rows and rb photoelectric conversion element rows is executed.

During the driving in the moving image photographing mode, in the vertical charge transfer passage 54 corresponding to each G photoelectric conversion element column, an empty packet is formed at the position corresponding to each of RB charge storing packet and G charge storing packet formed in the vertical charge transfer passage 54 one the left side of the G photoelectric conversion element column. Since a smear charge is stored in the empty packet, the empty packet can be used as a smear charge detecting packet.

Letting the signal obtained from the R photoelectric conversion element 51 be R signal, the signal obtained from the G photoelectric conversion element 52 be G signal, the signal obtained from the B photoelectric conversion element 53 be B signal, and the signal obtained from the empty packet be smear signal, according to the driving at the time of the moving image photographing mode, the signal of one line of the solid-state image pickup device 5 can be output in the order of B signal, smear signal, R signal, smear signal, B signal, smear signal, R signal, smear signal . . . . Then, in the embodiment, the analog signal processing section 6 performs processing of subtracting from the signal after correlated double sampling processing of each color signal, the signal after correlated double sampling processing of the smear signal output just before or just after the color signal, thereby also performing processing of executing smear correction of each color signal.

As described above, according to the solid-state image pickup device 5 of the embodiment, the charge read part 56 is also provided between each G photoelectric conversion element 52 and the vertical charge transfer passage 54 on the left side of the G photoelectric conversion element 52, so that the charges from the R photoelectric conversion element 51 and the B photoelectric conversion element 53 are read to the vertical charge transfer passage 54 through the charge read parts 55 and the charge from the G photoelectric conversion element 52 is read to the vertical charge transfer passage 54 through the charge read part 56 as in the driving at the time of the moving image photographing mode, whereby it is made possible to use the vertical charge transfer passage 54 corresponding to the G photoelectric conversion element column as the vertical charge transfer passage 54 for smear detection.

According to the solid-state image pickup device 5 of the embodiment, the empty packet formed in the vertical charge transfer passage 54 for smear detection and the RB charge storing packet and the G charge storing packet exist in the same line, so that a highly accurate smear correction can be made.

In the solid-state image pickup device 5 of the embodiment, only one charge read part is provided on the periphery of each of the R photoelectric conversion elements 51 and the B photoelectric conversion elements 53. Thus, a decrease in the opening areas of the R photoelectric conversion elements 51 and the B photoelectric conversion elements 53 can be prevented and degradation of the sensitivity can be prevented. Since two charge read parts are provided on the periphery of each G photoelectric conversion element 52, the opening area of the G photoelectric conversion element 52 becomes smaller than that of the R photoelectric conversion element 51 and that of the B photoelectric conversion element 53, but no problem arises because the sensitivity of the G photoelectric conversion element 52 is essentially high.

In the description made so far, the photoelectric conversion element provided with two charge read parts is each of the photoelectric conversion elements making up the G photoelectric conversion element column, but may be each of the photoelectric conversion elements making up the RB photoelectric conversion element column. This means that two charge read parts may be provided for each of the R photoelectric conversion elements 51 and the B photoelectric conversion elements 53 and one charge read part may be provided for each G photoelectric conversion element 52.

In the description made so far, the charge read part 56 is provided for all G photoelectric conversion elements 52 making up the G photoelectric conversion element column, but may be provided for at least some of the G photoelectric conversion elements 52 making up the G photoelectric conversion element column. For example, if half thinning is assumed to be performed as in the moving image photographing mode described above, the charge read parts 56 below the transfer electrode V4 may be omitted in FIG. 2. If the charge read part 56 is provided for all G photoelectric conversion elements 52, all pixel read provided that two-field read is performed is made possible.

Depending on the structure of the horizontal charge transfer passage 57, the charges obtained from two adjacent photoelectric conversion elements of the same type in the odd-numbered photoelectric conversion element row need to be added together in the horizontal charge transfer passage 57 and two adjacent smear charges in the same line as the charge needs to be added together in the horizontal charge transfer passage 57 before transfer in the row direction X.

### SECOND EMBODIMENT

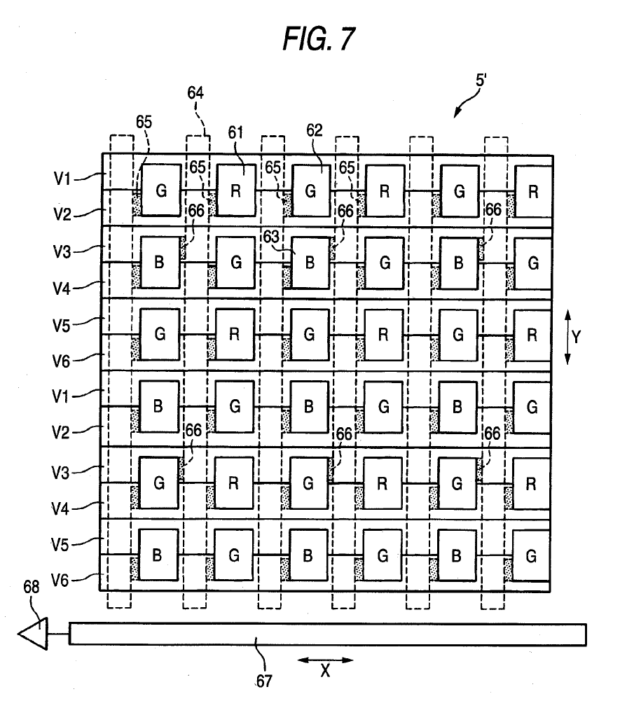

FIG. 7 is a plan pattern diagram to show another configuration example of the solid-state image pickup device 5 shown in FIG. 1.

A solid-state image pickup device 5′ shown in FIG. 7 includes R photoelectric conversion elements 61 for detecting R light, G photoelectric conversion elements 62 for detecting G light, and B photoelectric conversion elements 63 for detecting B light arranged like a tetragonal lattice in a row direction X and a column direction Y on a semiconductor substrate.

It can be said that the arrangement of the photoelectric conversion elements of the solid-state image pickup device 5′ is arranging of photoelectric conversion element columns made up of the G photoelectric conversion elements 62 and the B photoelectric conversion elements 63 arranged in the column direction Y (hereinafter, also called GB photoelectric conversion element columns) and photoelectric conversion element columns made up of the R photoelectric conversion elements 61 and the G photoelectric conversion elements 62 arranged in the column direction Y (hereinafter, also called RG photoelectric conversion element columns), alternately in the row direction X. It can also be said that the arrangement of the photoelectric conversion elements of the solid-state image pickup device 5′ is arranging of photoelectric conversion element rows made up of the G photoelectric conversion elements 62 and the R photoelectric conversion elements 61 arranged in the row direction X (hereinafter, also called GR photoelectric conversion element rows) and photoelectric conversion element rows made up of the B photoelectric conversion elements 63 and the G photoelectric conversion elements 62 arranged in the row direction X (hereinafter, also called BG photoelectric conversion element rows), alternately in the column direction Y.

On the left side of the GB photoelectric conversion element columns and the RG photoelectric conversion element columns, vertical charge transfer passages 64 for transferring charges stored in the photoelectric conversion elements making up the photoelectric conversion element columns are formed in a one-to-one correspondence with the photoelectric conversion element columns. The vertical charge transfer passage 64 is formed of n-type impurities poured into a p well layer formed on an n-type silicon substrate, for example.

Transfer electrodes V1 to V6 to which transfer pulses of six phases for transferring the charge read to the vertical charge transfer passage 64 are applied by an image pickup device drive section 10 are formed above the vertical charge transfer passage 64. Transfer pulse φV1 is applied to the transfer electrodes V1; transfer pulse φV2 is applied to the transfer electrodes V2; transfer pulse φV3 is applied to the transfer electrodes V3; transfer pulse φV4 is applied to the transfer electrodes V4; transfer pulse φV5 is applied to the transfer electrodes V5; and transfer pulse φV6 is applied to the transfer electrodes V6.

The transfer electrodes V1 to V6 are disposed in the row direction X between the photoelectric conversion element rows so as to avoid the photoelectric conversion elements making up the photoelectric conversion element rows.

The transfer electrode V1 is formed in the upper part of the (3n+1)st photoelectric conversion element row (n is a positive integer) counted from the upper end part of the solid-state image pickup device 5′. The transfer electrode V2 is formed in the lower part of the (3n+1)st photoelectric conversion element row counted from the upper end part of the solid-state image pickup device 5′.

The transfer electrode V3 is formed in the upper part of the (3n+2)nd photoelectric conversion element row counted from the upper end part of the solid-state image pickup device 5′. The transfer electrode V4 is formed in the lower part of the (3n+2)nd photoelectric conversion element row counted from the upper end part of the solid-state image pickup device 5′.

The transfer electrode V5 is formed in the upper part of the (3n+3)rd photoelectric conversion element row counted from the upper end part of the solid-state image pickup device 5′. The transfer electrode V6 is formed in the lower part of the (3n+3)rd photoelectric conversion element row counted from the upper end part of the solid-state image pickup device 5′.

Provided between each of the photoelectric conversion elements 61 to 63 and the vertical charge transfer passage 64 corresponding thereto is a charge read part 65 for reading a charge occurring in the corresponding element to the vertical charge transfer passage 64. The charge read part 65 is formed by a part of a p well layer formed on an n-type silicon substrate, for example.

The transfer electrode V2 is formed above the charge read part 65 provided adjacent to each photoelectric conversion element of the (3n+1)st photoelectric conversion element row counted from the upper end part of the solid-state image pickup device 5′. A read pulse is applied to the transfer electrode V2, whereby the charge stored in each photoelectric conversion element of the (3n+1)st photoelectric conversion element row can be read to the vertical charge transfer passage 64 on the left side of the corresponding photoelectric conversion element.

The transfer electrode V4 is formed above the charge read part 65 provided adjacent to each photoelectric conversion element of the (3n+2)nd photoelectric conversion element row counted from the upper end part of the solid-state image pickup device 5′. A read pulse is applied to the transfer electrode V4, whereby the charge stored in each photoelectric conversion element of the (3n+2)nd photoelectric conversion element row can be read to the vertical charge transfer passage 64 on the left side of the corresponding photoelectric conversion element.

The transfer electrode V6 is formed above the charge read part 65 provided adjacent to each photoelectric conversion element of the (3n+3)rd photoelectric conversion element row counted from the upper end part of the solid-state image pickup device 5′. A read pulse is applied to the transfer electrode V6, whereby the charge stored in each photoelectric conversion element of the (3n+3)rd photoelectric conversion element row can be read to the vertical charge transfer passage 64 on the left side of the corresponding photoelectric conversion element.

Formed between (i) the (3n+2)nd photoelectric conversion element counted from the upper end part of the solid-state image pickup device 5′, of the photoelectric conversion elements contained in the odd-numbered photoelectric conversion element column counted from the left end part of the solid-state image pickup device 5′ and (ii) the vertical charge transfer passage 64 existing on the right side of the photoelectric conversion element is a charge read part 66 for reading a charge stored in the photoelectric conversion element to the vertical charge transfer passage 64 existing on the right side of the photoelectric conversion element. The charge read part 66 is formed by a part of a p well layer formed on an n-type silicon substrate, for example.

The transfer electrode V3 is formed above the charge read part 66 and a read pulse is applied to the transfer electrode V3, whereby the charge stored in the (3n+2)nd photoelectric conversion element counted from the upper end part of the solid-state image pickup device 5′, of the photoelectric conversion elements contained in the odd-numbered photoelectric conversion element column counted from the left end part of the solid-state image pickup device 5′ can be read to the vertical charge transfer passage 64 on the right side of the photoelectric conversion element.

A horizontal charge transfer passage 67 for transferring the charge transferred over the vertical charge transfer passage 64 in the row direction X is connected to the vertical charge transfer passage 64. An output amplifier 68 for converting the charged transferred over the horizontal charge transfer passage 67 into a voltage signal and outputting the voltage signal is connected to the horizontal charge transfer passage 67.

Next, a drive method of the described solid-state image pickup device 5′ will be discussed.

(Still Image Photographing Mode)

When a still image photographing mode is set through an operation section 14, the image pickup device drive section 10 drives the solid-state image pickup device 5′ by a drive method responsive to the still image photographing mode under the control of a system control section 11.

After the expiration of an exposure period, the image pickup device drive section 10 sets high the transfer pulse to be applied to the transfer electrode V2 and reads the charges stored in the photoelectric conversion elements of the (3n+1)st photoelectric conversion element row to the vertical charge transfer passage 64 through the charge read parts 65. After reading the charges, the image pickup device drive section 10 applies transfer pulses of a predetermined pattern to the transfer electrodes V1 to V6, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Next, the image pickup device drive section 10 sets high the transfer pulse to be applied to the transfer electrode V4 and reads the charges stored in the photoelectric conversion elements of the (3n+2)nd photoelectric conversion element row to the vertical charge transfer passage 64 through the charge read parts 65. After reading the charges, the image pickup device drive section 10 applies transfer pulses of a predetermined pattern to the transfer electrodes V1 to V6, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Next, the image pickup device drive section 10 sets high the transfer pulse to be applied to the transfer electrode V6 and reads the charges stored in the photoelectric conversion elements of the (3n+3)rd photoelectric conversion element row to the vertical charge transfer passage 64 through the charge read parts 65. After reading the charges, the image pickup device drive section 10 applies transfer pulses of a predetermined pattern to the transfer electrodes V1 to V6, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Thus, the charges from all photoelectric conversion elements can be read as they are separated into three fields.

(Moving Image Photographing Mode)

When a moving image photographing mode is set through the operation section 14, the image pickup device drive section 10 drives the solid-state image pickup device 5′ by a drive method responsive to the moving image photographing mode under the control of the system control section 11.

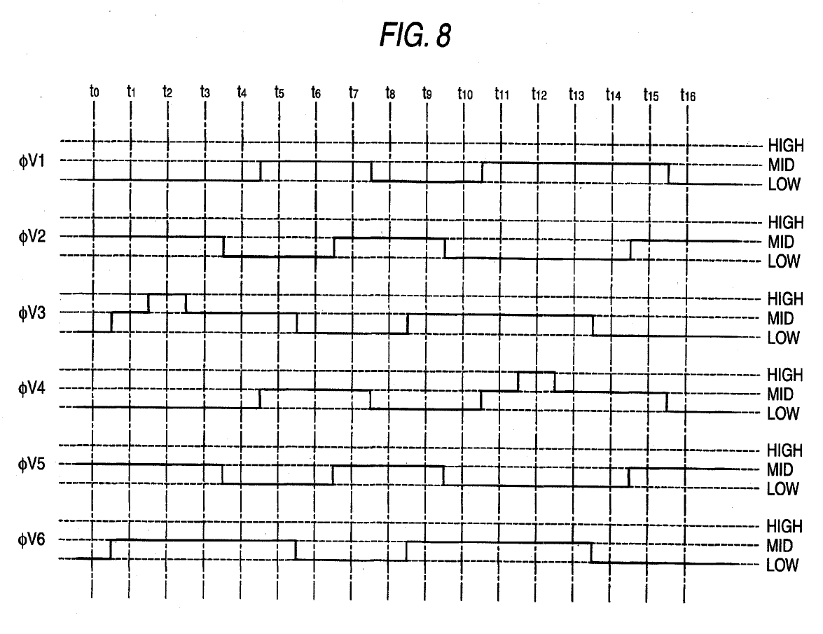

FIG. 8 is a timing chart to show the transfer pulse state at the time of the moving image photographing mode of the solid-state image pickup device of the second embodiment of the invention.

After the expiration of an exposure period, the image pickup device drive section 10 sets middle the transfer pulse to be applied to the transfer electrode V2, V3, V5, V6 at a time t1 and forms a charge storing packet in the vertical charge transfer passage 64 below the transfer electrode V2, V3 and in the vertical charge transfer passage 64 below the transfer electrode V5, V6. Next, the image pickup device drive section 10 superposes a high read pulse on the transfer pulse to be applied to the transfer electrode V3 at a time t2 and reads the charge stored in the photoelectric conversion element adjacent to the charge read part 66 to the charge storing packet formed in the vertical charge transfer passage 64 on the right side of the photoelectric conversion element through the charge read part 66.

Next, the image pickup device drive section 10 moves the charge storing packet below the transfer electrode V2, V3 to below the transfer electrode V6, V1 at times t3 to t11 and moves the charge storing packet below the transfer electrode V5, V6 to below the transfer electrode V3, V4. Next, the image pickup device drive section 10 superposes a high read pulse on the transfer electrode V4 at a time t12 and reads the charge stored in the (3n+2)nd photoelectric conversion element counted from the upper end part of the photoelectric conversion elements making up an even-numbered photoelectric conversion element column to the charge storing packet in the vertical charge transfer passage 64 on the left side of the photoelectric conversion element through the charge read part 65. After the time 12, the image pickup device drive section 10 applies transfer pulses of a predetermined pattern to the transfer electrodes V1 to V6, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, outputs a signal responsive to the charges from the output amplifier 68, and completes photographing of one frame.

Also in the solid-state image pickup device 5′, like the solid-state image pickup device 5, during the driving in the moving image photographing mode, in the vertical charge transfer passage 64 corresponding to the odd-numbered photoelectric conversion element column, an empty packet is formed at the position corresponding to the charge storing packet formed in the vertical charge transfer passage 64 on the right side of the photoelectric conversion element column. Since a smear charge is stored in the empty packet, the empty packet can be used as a smear charge detecting packet.

According to the driving at the time of the moving image photographing mode, the signal of one line of the solid-state image pickup device 5′ can be output in the order of smear signal, color (R or G or B) signal, smear signal, color (R or G or B) signal, smear signal, color (R or G or B) signal . . . . Then, also in the embodiment, an analog signal processing section 6 performs processing of subtracting from the signal after correlated double sampling processing of each color signal, the signal after correlated double sampling processing of the smear signal output just before or just after the color signal, thereby performing processing of executing smear correction of each color signal.

As described above, according to the solid-state image pickup device 5′ of the embodiment, the charge read part 66 is also provided between each of some of the photoelectric conversion elements making up each odd-numbered photoelectric conversion element column and the vertical charge transfer passage 64 on the right side of the photoelectric conversion element, so that the charge from the photoelectric conversion element adjacent to the charge read part 66 is read to the vertical charge transfer passage 64 through the charge read part 66 as in the driving at the time of the moving image photographing mode, whereby it is made possible to use the vertical charge transfer passage 64 corresponding to each odd-numbered photoelectric conversion element column as the vertical charge transfer passage 64 for smear detection.

According to the solid-state image pickup device 5′ of the embodiment, the empty packet formed in the vertical charge transfer passage 64 for smear detection and the charge storing packet formed in the vertical charge transfer passage 64 corresponding to each even-numbered photoelectric conversion element column exist in the same line, so that a highly accurate smear correction can be made.

In the solid-state image pickup device 5′ of the embodiment, two charge read parts are provided on the periphery of each of some photoelectric conversion elements only and thus a decrease in the opening areas of the photoelectric conversion elements other than some photoelectric conversion elements can be prevented and degradation of the sensitivity can be prevented.

In the description made so far, the photoelectric conversion element provided with two charge read parts is the photoelectric conversion element contained in each odd-numbered photoelectric conversion element column, but may be the photoelectric conversion element contained in each even-numbered photoelectric conversion element column.

### THIRD EMBODIMENT

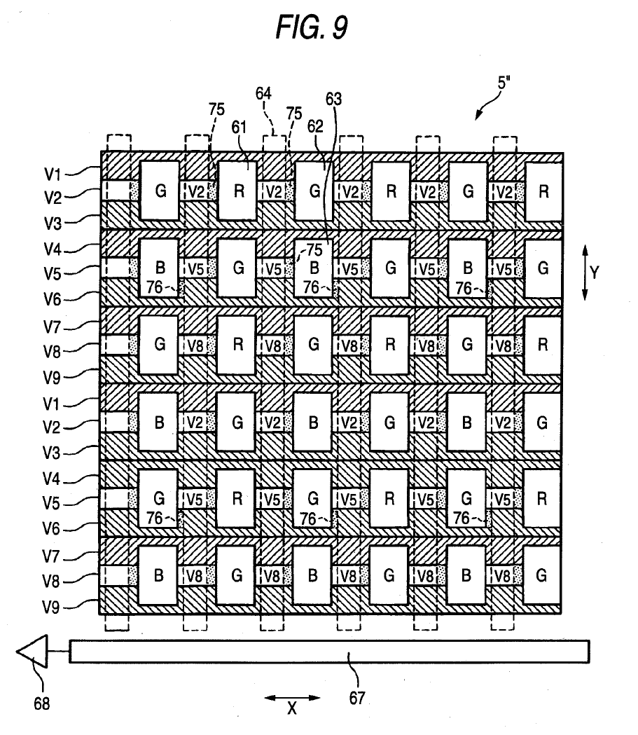

FIG. 9 is a plan pattern diagram to show another configuration example of the solid-state image pickup device 5 shown in FIG. 1.

A solid-state image pickup device 5″ shown in FIG. 9 includes R photoelectric conversion elements 61, G photoelectric conversion elements 62, B photoelectric conversion elements 63, vertical charge transfer passages 64, a horizontal charge transfer passage 67, and an output amplifier 68, which are the same as those shown in FIG. 7.

Transfer electrodes V1 to V9 to which transfer pulses of nine phases for transferring the charge read to the vertical charge transfer passage 64 are applied by an image pickup device drive section 10 are formed above the vertical charge transfer passage 64. Transfer pulse φV1 is applied to the transfer electrodes V1; transfer pulse φV2 is applied to the transfer electrodes V2; transfer pulse φV3 is applied to the transfer electrodes V3; transfer pulse φV4 is applied to the transfer electrodes V4; transfer pulse φV5 is applied to the transfer electrodes V5; transfer pulse φV6 is applied to the transfer electrodes V6, transfer pulse φV7 is applied to the transfer electrodes V7; transfer pulse φV8 is applied to the transfer electrodes V8; and transfer pulse φV9 is applied to the transfer electrodes V9.

The transfer electrodes V1, V3, V4, V6, V7, and V9 are disposed in a row direction X between photoelectric conversion element rows so as to avoid the photoelectric conversion element rows.

In the upper part of the (3n+1)st photoelectric conversion element row counted from the upper end part of the solid-state image pickup device 5″, the transfer electrode V1 is formed between the photoelectric conversion element row and its adjacent photoelectric conversion element row. In the lower part of the (3n+1)st photoelectric conversion element row counted from the upper end part of the solid-state image pickup device 5″, the transfer electrode V3 is formed between the photoelectric conversion element row and its adjacent photoelectric conversion element row.

Transfer electrodes V2 are formed between the transfer electrodes V1 and V3 and are connected to common wiring, so that the same pulse can be applied to all transfer electrodes V2 at the same time.

In the upper part of the (3n+2)nd photoelectric conversion element row counted from the upper end part of the solid-state image pickup device 5″, the transfer electrode V4 is formed between the photoelectric conversion element row and its adjacent photoelectric conversion element row. In the lower part of the (3n+2)nd photoelectric conversion element row counted from the upper end part of the solid-state image pickup device 5″, the transfer electrode V6 is formed between the photoelectric conversion element row and its adjacent photoelectric conversion element row.

Transfer electrodes V5 are formed between the transfer electrodes V4 and V6 and are connected to common wiring, so that the same pulse can be applied to all transfer electrodes V5 at the same time.

In the upper part of the (3n+3)rd photoelectric conversion element row counted from the upper end part of the solid-state image pickup device 5″, the transfer electrode V7 is formed between the photoelectric conversion element row and its adjacent photoelectric conversion element row. In the lower part of the (3n+3)rd photoelectric conversion element row counted from the upper end part of the solid-state image pickup device 5″, the transfer electrode V9 is formed between the photoelectric conversion element row and its adjacent photoelectric conversion element row.

Transfer electrodes V8 are formed between the transfer electrodes V7 and V9 and are connected to common wiring, so that the same pulse can be applied to all transfer electrodes V8 at the same time.

Provided between each of the photoelectric conversion elements 61 to 63 and the vertical charge transfer passage 64 corresponding thereto is a charge read part 75 for reading a charge occurring in the corresponding element to the vertical charge transfer passage 64. The charge read part 75 is formed by a part of a p well layer formed on an n-type silicon substrate, for example.

The transfer electrode V2 is formed above the charge read part 75 corresponding to each photoelectric conversion element of the (3n+1)st photoelectric conversion element row counted from the upper end part of the solid-state image pickup device 5″. A read pulse is applied to the transfer electrode V2, whereby the charge stored in each photoelectric conversion element of the (3n+1)st photoelectric conversion element row can be read to the vertical charge transfer passage 64 on the left side of the corresponding photoelectric conversion element.

The transfer electrode V5 is formed above the charge read part 75 corresponding to each photoelectric conversion element of the (3n+2)nd photoelectric conversion element row counted from the upper end part of the solid-state image pickup device 5″. A read pulse is applied to the transfer electrode V5, whereby the charge stored in each photoelectric conversion element of the (3n+2)nd photoelectric conversion element row can be read to the vertical charge transfer passage 64 on the left side of the corresponding photoelectric conversion element.

The transfer electrode V8 is formed above the charge read part 75 corresponding to each photoelectric conversion element of the (3n+3)rd photoelectric conversion element row counted from the upper end part of the solid-state image pickup device 5″. A read pulse is applied to the transfer electrode V8, whereby the charge stored in each photoelectric conversion element of the (3n+3)rd photoelectric conversion element row can be read to the vertical charge transfer passage 64 on the left side of the corresponding photoelectric conversion element.

Formed between the (3n+2)nd photoelectric conversion element counted from the upper end part of the solid-state image pickup device 5″, of the photoelectric conversion elements contained in the odd-numbered photoelectric conversion element column counted from the left end part of the solid-state image pickup device 5″ and the vertical charge transfer passage 64 existing on the right side of the photoelectric conversion element is a charge read part 76 for reading a charge stored in the photoelectric conversion element to the vertical charge transfer passage 64 existing on the right side of the photoelectric conversion element. The charge read part 76 is formed by a part of a p well layer formed on an n-type silicon substrate, for example.

The transfer electrode V6 is formed above the charge read part 76 and a read pulse is applied to the transfer electrode V6, whereby the charge stored in the (3n+2)nd photoelectric conversion element counted from the upper end part of the solid-state image pickup device 5″, of the photoelectric conversion elements contained in the odd-numbered photoelectric conversion element column counted from the left end part of the solid-state image pickup device 5″ can be read to the vertical charge transfer passage 64 on the right side of the photoelectric conversion element.

Next, a drive method of the described solid-state image pickup device 5″ will be discussed.

(Still Image Photographing Mode)

When a still image photographing mode is set through an operation section 14, the image pickup device drive section 10 drives the solid-state image pickup device 5″ by a drive method responsive to the still image photographing mode under the control of a system control section 11.

After the expiration of an exposure period, the image pickup device drive section 10 sets high the transfer pulse to be applied to the transfer electrode V2 and reads the charges stored in the photoelectric conversion elements of the (3n+1)st photoelectric conversion element row to the vertical charge transfer passage 64 through the charge read parts 75. After reading the charges, the image pickup device drive section 10 applies transfer pulses of nine phases to the transfer electrodes V1 to V9, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Next, the image pickup device drive section 10 sets high the transfer pulse to be applied to the transfer electrode V5 and reads the charges stored in the photoelectric conversion elements of the (3n+2)nd photoelectric conversion element row to the vertical charge transfer passage 64 through the charge read parts 75. After reading the charges, the image pickup device drive section 10 applies transfer pulses of nine phases to the transfer electrodes V1 to V9, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Next, the image pickup device drive section 10 sets high the transfer pulse to be applied to the transfer electrode V8 and reads the charges stored in the photoelectric conversion elements of the (3n+3)rd photoelectric conversion element row to the vertical charge transfer passage 64 through the charge read parts 75. After reading the charges, the image pickup device drive section 10 applies transfer pulses of nine phases to the transfer electrodes V1 to V9, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, and outputs a signal responsive to the charges from the output amplifier 68.

Thus, the charges from all photoelectric conversion elements can be read as they are separated into three fields.

(Moving Image Photographing Mode)

When a moving image photographing mode is set through the operation section 14, the image pickup device drive section 10 drives the solid-state image pickup device 5″ by a drive method responsive to the moving image photographing mode under the control of the system control section 11.

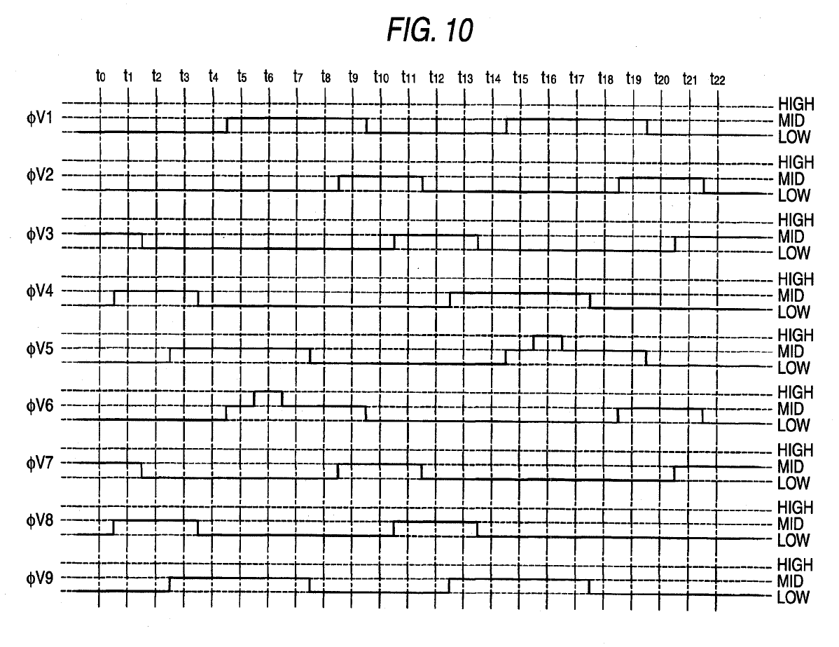

FIG. 10 is a timing chart to show the transfer pulse state at the time of the moving image photographing mode of the solid-state image pickup device of the third embodiment of the invention.

After the expiration of an exposure period, the image pickup device drive section 10 sets middle the transfer pulse to be applied to the transfer electrode V5, V6, V9, V1 at a time t5 and forms a charge storing packet in the vertical charge transfer passage 64 below the transfer electrode V5, V6 and in the vertical charge transfer passage 64 below the transfer electrode V9, V1. Next, the image pickup device drive section 10 superposes a high read pulse on the transfer pulse to be applied to the transfer electrode V6 at a time t6 and reads the charge stored in the photoelectric conversion element adjacent to the charge read part 76 to the charge storing packet formed in the vertical charge transfer passage 64 on the right side of the photoelectric conversion element through the charge read part 76.

Next, the image pickup device drive section 10 moves the charge storing packet below the transfer electrode V5, V6 to below the transfer electrode V9, V1 at times t7 to t15 and moves the charge storing packet below the transfer electrode V9, V1 to below the transfer electrode V4, V5. Next, the image pickup device drive section 10 superposes a high read pulse on the transfer electrode V5 at a time t16 and reads the charge stored in the (3n+2)nd photoelectric conversion element counted from the upper end part of the photoelectric conversion elements making up an even-numbered photoelectric conversion element column to the charge storing packet in the vertical charge transfer passage 64 in the left part of the photoelectric conversion element through the charge read part 75. After the time 16, the image pickup device drive section 10 applies transfer pulses of nine phases to the transfer electrodes V1 to V9, thereby transferring the charges read to the vertical charge transfer passage 64 to the horizontal charge transfer passage 67 and then applies transfer pulses of two phases to the horizontal charge transfer passage 67, transfers the charges transferred to the horizontal charge transfer passage 67 in the row direction X, outputs a signal responsive to the charges from the output amplifier 68, and completes photographing of one frame.

Also in the solid-state image pickup device 5″, like the solid-state image pickup device 5, during the driving in the moving image photographing mode, in the vertical charge transfer passage 64 corresponding to the odd-numbered photoelectric conversion element column, an empty packet is formed at the position corresponding to the charge storing packet formed in the vertical charge transfer passage 64 on the right side of the photoelectric conversion element column. Since a smear charge is stored in the empty packet, the empty packet can be used as a smear charge detecting packet.

According to the driving at the time of the moving image photographing mode, the signal of one line of the solid-state image pickup device 5″ can be output in the order of smear signal, color (R or G or B) signal, smear signal, color (R or G or B) signal, smear signal, color (R or G or B) signal . . . . Then, also in the embodiment, an analog signal processing section 6 performs processing of subtracting from the signal after correlated double sampling processing of each color signal, the signal after correlated double sampling processing of the smear signal output just before or just after the color signal, thereby performing processing of executing smear correction of each color signal.

As described above, according to the solid-state image pickup device 5″ of the embodiment, the charge read part 76 is also provided between each of some of the photoelectric conversion elements making up each odd-numbered photoelectric conversion element column and the vertical charge transfer passage 64 on the right side of the photoelectric conversion element, so that the charge from the photoelectric conversion element adjacent to the charge read part 76 is read to the vertical charge transfer passage 64 through the charge read part 76 as in the driving at the time of the moving image photographing mode, whereby it is made possible to use the vertical charge transfer passage 64 corresponding to each odd-numbered photoelectric conversion element column as the vertical charge transfer passage 64 for smear detection.

According to the solid-state image pickup device 5″ of the embodiment, the empty packet formed in the vertical charge transfer passage 64 for smear detection and the charge storing packet formed in the vertical charge transfer passage 64 corresponding to each even-numbered photoelectric conversion element column exist in the same line, so that a highly accurate smear correction can be made.

In the solid-state image pickup device 5″ of the embodiment, two charge read parts are provided on the periphery of each of some photoelectric conversion elements only and thus a decrease in the opening areas of the photoelectric conversion elements other than some photoelectric conversion elements can be prevented and degradation of the sensitivity can be prevented.

In the description made so far, the photoelectric conversion element provided with two charge read parts is the photoelectric conversion element contained in each odd-numbered photoelectric conversion element column, but may be the photoelectric conversion element contained in each even-numbered photoelectric conversion element column.

What is claimed is:

1. A solid-state image pickup device comprising:
a plurality of photoelectric conversion element columns each having a plurality of photoelectric conversion elements arranged in a predetermined direction, the plurality of photoelectric conversion element columns which are disposed in an orthogonal direction to the predetermined direction;
a charge transfer passage being provided corresponding to each of the photoelectric conversion element columns on a side of the photoelectric conversion element column for transferring charge occurring in the photoelectric conversion elements contained in the photoelectric conversion element column in the predetermined direction;
a first charge read part being provided between the charge transfer passage and each of the photoelectric conversion elements contained in the photoelectric conversion element column corresponding to the charge transfer passage for reading the charge stored in the corresponding photoelectric conversion element to the charge transfer passage, the photoelectric conversion element columns arranged alternately in the orthogonal direction being first photoelectric conversion element columns and other photoelectric conversion element columns being second photoelectric conversion element columns; and
a second charge read part being provided between each of at least some of the photoelectric conversion elements contained in the second photoelectric conversion element column and the charge transfer passage on the opposite side of the second photoelectric conversion element column to the side where the charge transfer passage corresponding to the second photoelectric conversion element column exists for reading the chare stored in the corresponding photoelectric conversion element to the charge transfer passage on the opposite side.

2. The solid-state image pickup device according to claim 1, wherein
a read pulse that reads out the charge from the photoelectric conversion element to the charge transfer passage and
the read pulse is applied separately to the second charge read part and the first charge read part adjacent to each of at least some of the photoelectric conversion elements.

3. The solid-state image pickup device according to claim 1, wherein
each of the first photoelectric conversion element columns has a B photoelectric conversion element for detecting light in a blue wave range and an R photoelectric conversion element for detecting light in a red wave range, and
each of the second photoelectric conversion element columns has G photoelectric conversion elements for detecting light in a green wave range.

4. The solid-state image pickup device according to claim 1, wherein
the first and second photoelectric conversion element columns are shifted from each other in the predetermined direction roughly by a half of the arrangement pitch of the photoelectric conversion elements contained each of the photoelectric conversion element columns.

5. An image pickup apparatus comprising:
a solid-state image pickup device according to claim 1; and
a drive unit that drives the solid-state image pickup device in different types of drive modes, wherein
the different types of drive modes contain a first drive mode and a second drive mode,
the first drive mode is a drive mode for applying a read pulse for reading the charge from each of the photoelectric conversion elements to the charge transfer passage to the first charge read part, reading the charges stored in the photoelectric conversion elements contained in the first photoelectric conversion element column to the charge transfer passage corresponding to the first photoelectric conversion element column, and reading the charges stored in the photoelectric conversion elements contained in the second photoelectric conversion element column to the charge transfer passage corresponding to the second photoelectric conversion element column, and applying a predetermined pulse to the charge transfer passage and transferring the charges read to the charge transfer passage corresponding to the first photoelectric conversion element column and the charges read to the charge transfer passage corresponding to the second photoelectric conversion element column in the predetermined direction, and
the second drive mode is a drive mode for applying the read pulse to each of the first charge read parts adjacent to the first photoelectric conversion element column and reading the charges stored in the photoelectric conversion elements contained in the first photoelectric conversion element column to the charge transfer passage corresponding to the first photoelectric conversion element column, applying the read pulse to each of the second charge read parts adjacent to the second photoelectric conversion element column and reading the charges stored in the photoelectric conversion elements contained in the second photoelectric conversion element column to the charge transfer passage corresponding to the first photoelectric conversion element column adjacent to the second photoelectric conversion element column, and applying a predetermined pulse to the charge transfer passage and transferring the charges read to the charge transfer passage corresponding to the first photoelectric conversion element column and smear charge existing in the charge transfer passage corresponding to the second photoelectric conversion element column in the predetermined direction.

6. The image pickup apparatus according to claim 5, further comprising:
a smear correction unit executes smear correction by subtracting a signal responsive to the charges transferred over the charge transfer passage corresponding to the second photoelectric conversion element column adjacent to the first photoelectric conversion element column from a signal responsive to the charges transferred over the charge transfer passage corresponding to the first photoelectric conversion element column, output from the solid-state image pickup device according to the second drive mode.

7. A drive method comprising:
driving a solid-state image pickup device according to claim 1 by selecting any of different types of drive modes which contain a first drive mode and a second drive mode,
wherein the first drive mode includes:
applying a read pulse for reading the charge from each of the photoelectric conversion elements to the charge transfer passage to the first charge read part;
reading the charges stored in the photoelectric conversion elements contained in the first photoelectric conversion element column to the charge transfer passage corresponding to the first photoelectric conversion element column; and
reading the charges stored in the photoelectric conversion elements contained in the second photoelectric conversion element column to the charge transfer passage corresponding to the second photoelectric conversion element column;
applying a predetermined pulse to the charge transfer passage; and
transferring the charges read to the charge transfer passage corresponding to the first photoelectric conversion element column and the charges read to the charge transfer passage corresponding to the second photoelectric conversion element column in the predetermined direction, and
the second drive mode includes:
applying the read pulse to each of the first charge read parts adjacent to the first photoelectric conversion element column;
reading the charges stored in the photoelectric conversion elements contained in the first photoelectric conversion element column to the charge transfer passage corresponding to the first photoelectric conversion element column;
applying the read pulse to each of the second charge read parts adjacent to the second photoelectric conversion element column;
reading the charges stored in the photoelectric conversion elements contained in the second photoelectric conversion element column to the charge transfer passage corresponding to the first photoelectric conversion element column adjacent to the second photoelectric conversion element column;
applying a predetermined pulse to the charge transfer passage; and
transferring the charges read to the charge transfer passage corresponding to the first photoelectric conversion element column and smear charge existing in the charge transfer passage corresponding to the second photoelectric conversion element column in the predetermined direction.
